(19) United States
(12) Patent Application Publication
(10) Pub. No.: US 2009/0153934 A1
(43) Pub. Date: Jun. 18, 2009

(54) OPTICAL SCANNER AND IMAGE FORMING APPARATUS

(76) Inventor: Katsunori Shoji, Chigasaki-shi (JP)

Correspondence Address: DICKSTEIN SHAPIRO LLP, 1825 EYE STREET NW, Washington, DC, 20006-5403, US

(21) Appl. No.: 12/332,523

(22) Filed: Dec. 11, 2008

(30) Foreign Application Priority Data
Dec. 13, 2007 (JP) 2007-321602

(51) Int. Cl. G02B 26/10; G02B 7/185

(52) U.S. Cl. 359/205.1; 359/846

(57) ABSTRACT

A curvature-adjustment device used for an optical scanner that includes an optical beam emission unit to emit an optical beam, a deflection unit to deflect the optical beam in a main scanning direction and a mirror to reflect the optical beam. The curvature-adjustment device corrects a curvature of a main scanning line on a surface of a scanning target, and includes a support unit to support the mirror at an end thereof by contacting a rear surface of the mirror, an edge-positioned adjustment unit to curve the mirror by exerting a first force, a center-positioned adjustment unit to curve the mirror reversely in a direction to which the edge-positioned adjustment unit curves the mirror by providing a second force perpendicular to the reflecting surface at a center of the mirror, and a fine adjustment unit to adjust the strength of the first force depending on the strength of the second force.

### CROSS-REFERENCE TO RELATED APPLICATIONS

This application claims priority to Japanese Patent Application No. 2007-321602, filed on Dec. 13, 2007, the entire contents of which are hereby incorporated by reference herein.

### BACKGROUND

1. Field of the Invention

The present invention relates to an optical scanner and an image forming apparatus capable of correcting the curvature of a scanning line on a scanning target.

2. Description of the Related Art

An image forming apparatus that employs an electrophotographic method, such as a printer, a copier, a facsimile machine, or a multi-function system, commonly applies toner as dry ink to make visible an image in an image forming operation.

There are two main types of full-color image forming apparatuses that employ electrophotography. One is a single-drum-type full-color image forming apparatus, and the other is a tandem-type full-color image forming apparatus.

The tandem-type full-color image forming apparatus includes a plurality of image carriers such as photoreceptors. A plurality of electrostatic latent images is formed on the image carriers by scanning optical beams. The electrostatic latent images are developed using a plurality of different color toner to develop the electrostatic latent images into visible toner images. The visible toner images on the image carriers are then superimposed on top of each other onto a recording medium to form a full-color image.

In such a configuration, the visible toner images can sometimes get misaligned relative to each other on the plurality of the image carriers. As a result, when the visible toner images are transferred, the final image will be blurred because the toner images are misaligned.

One cause of such misalignment is undesirable curvature of a scanning line generated by the optical scanner in a main scanning direction (hereinafter main scanning line) on a surface of the image carrier.

More specifically, in an optical scanner that scans the surface of the image carrier with an optical beam, it is difficult to avoid subtle distortions between different optical parts, support members, and so on in the manufacture of the scanner. Further, subtle thermal deformation of the optical parts and the support members may occur during optical scanning because a motor that drivers the scanner generates heat. Further still, there may be an error in assembling the optical parts and the support members. Consequently, the main scanning line on the image carrier is not straight but instead curves due to distortion caused by errors in manufacture and assembly as well as thermal deformation from the heat of the motor.

FIG. 1 is an oblique perspective view of a photoreceptor 10 and a main scanning line. In FIG. 1, a dotted line designated La represents a main scanning line under ideal conditions, in which the main scanning line is a perfectly straight line. By contrast, a solid line designated Lb and a dash-single-dot line designated Lc represent main scanning lines that are curved.

The one main scanning line Lb curves so that a center portion of the main scanning line projects toward a downstream side of a sub-scanning direction with respect to both ends of the main scanning line. The other main scanning line Lc curves so that the center portion of the main scanning line projects toward an upstream side of the sub-scanning direction with respect to both ends of the main scanning line. The direction of the curvature of the main scanning line differs with each individual product because such curvature is caused by an accumulation of errors such as distortions among a variety of different parts, thermal deformation, assembly error, and so on.

As described above, the tandem-type full-color image forming apparatus includes a plurality of photoreceptors, with the direction of curvature (hereinafter also “curving direction”) of the main scanning line different for each individual photoreceptor. If the curving direction of the main scanning line on one photoreceptor differs from the curving direction of the main scanning line on the other photoreceptors, a positional misalignment relative to each visible image formed on the photoreceptors increases. Ultimately, the image is destroyed by color misalignment.

Therefore, it is necessary to correct the curvature of the main scanning line to reduce color misalignment even if each main scanning line on the plurality of the photoreceptors curves in different directions.

Many methods have been tried to solve this problem. One solution is to employ an optical scanner having a curvature-adjustment mechanism that corrects the curvature of a main scanning line on a photoreceptor by curving a mirror forcibly to correct the curvature of the mirror.

FIG. 2 is a magnified view showing a reflecting mirror 46 and an associated configuration of an optical scanner. The optical scanner includes a plurality of mirrors that reflect an optical write beam a predetermined number of times, of which the reflecting mirror 46 is one. The optical write beam reflected by the reflecting mirror 46 is ultimately exposed on the photoreceptor.

In this instance, the reflecting mirror 46 is held by a holder 52 provided on a rear surface (non-reflecting surface) of the reflecting mirror 46. Support projections 52a and 52b are provided at both ends of the holder 52 in a longitudinal direction thereof extending to the reflecting mirror 46. The support projections 52a and 52b are support means that contact the rear surface of the reflecting mirror 46.

At least one plate spring member, not shown, is provided at a position closer to the center of the reflecting mirror 46 in the longitudinal direction than the support projection of the holder 52. The plate spring member is an edge-positioned forcible-curving means. The plate spring member pushes the reflecting mirror 46 from a reflecting surface side toward the rear. Accordingly, a center portion of the reflecting mirror 46 is curved in a direction from the reflecting surface to the rear surface (shown by arrow A in FIG. 2). In other words, the reflecting mirror 46 is held by the holder 52 in a state in which the reflecting mirror 46 is forcibly curved by the one or more plate spring members. A forcible-curving unit 64 is provided at the rear side of the holder 52 to push the center portion of the reflecting mirror 46 in a direction (shown by arrow B in FIG. 2) that is the opposite of the direction in which the forcible-curving force is exerted by the one or more plate spring members through the holder 52.

FIG. 3 is a schematic diagram of the reflecting mirror 46 forcibly curved by the plate spring members. In a state in which the forcible-curving means (the forcible-curving unit indicated by reference numeral 64 in FIG. 2) does not push against the reflecting mirror 46 to adjust the curvature thereof, the reflecting mirror is forcibly curved in a way indicated by arrow R in FIG. 3. However, when the forcible-curving means even slightly pushes the reflecting mirror 46 in the direction shown by the arrow B, the reflecting mirror 46 is forcibly curved in a direction opposite the forcible curvature of the reflecting mirror 46 caused by the plate spring members, thus reducing the curvature of the reflecting mirror 46 as shown in FIG. 4. If the forcible-curving means 64 further pushes against the reflecting mirror 46, the reflecting mirror 46 curves reversely from an initial state, as shown in FIG. 5.

Accordingly, it is possible to correct the curvature of the reflecting mirror 46 to any direction (to the rear surface side or to the reflecting surface side) in this reflecting optical system. Thus, it is possible to correct both curvatures of the main scanning lines i.e., the main scanning line shown by the solid line Lb and the main scanning line shown by the dash-single-dot line Lc in FIG. 1. As a result, color misalignment due to the curvature of the main scanning line can be reduced.

However, if the main scanning line has a different shape from the other main scanning lines, color misalignment is generated even after performing a correction process like that described above.

FIG. 6 is a schematic diagram showing the main scanning lines on one of the photoreceptors correction. FIG. 7 is a schematic diagram showing the main scanning lines on the other photoreceptor correction. In FIGS. 6 and 7, each dotted line represents an ideal main scanning line that is a straight line extending in the main scanning direction. By contrast, the solid line represents an actual main scanning line. The actual main scanning line has a waved-like shape having a wave height At as shown in FIGS. 6 and 7 because of a following reason.

At an initial state of curvature in one or another of a curving direction, when the center of the reflecting mirror in a longitudinal direction thereof is pushed by the forcible-curving means 64, the center of the reflecting mirror slightly projects reversely from the curving direction. Accordingly, the main scanning line will have the wave-like shape. Further, the shapes of the main scanning lines on the two photoreceptors differ from each other as shown in FIGS. 6 and 7.

More specifically, with the main scanning line shown in FIG. 6, the center of the reflecting mirror along the main scanning line is projected in a direction indicated by arrow C in FIG. 6, while intermediate portions remain curved in a direction opposite the direction indicated by the arrow C. Thus, the main scanning line has a W-shaped form.

By contrast, FIG. 7 represents the inverse of the situation shown in FIG. 6 in which the positions of the plate spring member and the curving member are reversed, in which case the main scanning line has an M-like shape.

In the state shown in FIGS. 6 and 7, however, because the main scanning lines on the two photoreceptors have different shapes, the final full-color image will be blurred due to misalignment between a dot formed at a bottom portion of the W-shape of the main scanning line, for example, and a dot formed at a top portion of the M-shape of the main scanning line while superimposing the color images.

It has been confirmed experimentally that, if the pressure of the plate spring member on the reflecting mirror is stronger than a force exerted by of the forcible-curving means 64 that pushes the reflecting mirror in the opposite direction in which it is pressed by the plate spring member, the force exerted by the plate spring member dominates the force exerted by the forcible-curving means 64 only in a region between a pushing position of the forcible-curving means 64 and a support position of the support projection 52a. Accordingly, the refection mirror is curved smoothly not in the direction of the pushing force of the forcible-curving means 64 but in the direction of the pressure force of the plate spring member. Thus, the shape of the curvature becomes the W-shape or M-shape forms shown in FIGS. 6 and 7.

If the reflecting mirror is pushed further, the plate spring members are compressed so that the pressure force of the plate spring member increases. As a result, the reflecting mirror is curved further to have an even more exaggerated W-shape or M-shape forms.

To solve this problem, the pushing force of the forcible-curving means 64 could simply be reduced. However, if the pushing force of the forcible-curving means 64 is determined by the tolerance of the support projections, the pushing force of the forcible-curving means 64 may be set much weaker than necessary. If the pushing force of the forcible-curving means 64 is set much weaker than necessary, the curvature of the reflecting mirror may not be sufficiently corrected. Accordingly, it may not be possible to correct both curvatures of the main scanning lines Lb (shown by a solid line) and Lc (shown by a dash-single-dot line) in FIG. 1.

### SUMMARY

This patent specification describes a novel curvature-adjustment device used for an optical scanner that includes an optical beam emission unit to emit an optical beam, a deflection unit to deflect the optical beam in a main scanning direction and a mirror to reflect the optical beam. The curvature-adjustment device corrects a curvature of a main scanning line on a surface of a scanning target, and includes a support unit to support the mirror at an end thereof by contacting a rear surface of the mirror, an edge-positioned adjustment unit to curve the mirror by exerting a first force, a center-positioned adjustment unit to curve the mirror reversely in a direction to which the edge-positioned adjustment unit curves the mirror by providing a second force perpendicular to the reflecting surface at a center of the mirror, and a fine adjustment unit to adjust the strength of the first force depending on the strength of the second force.

This patent specification further describes a curvature-adjustment device used for an optical scanner that includes an optical beam emission unit to emit an optical beam, a deflection unit to deflect the optical beam in a main scanning direction and a mirror to reflect the optical beam. The curvature-adjustment device includes a fine adjustment unit to correct a curvature of a main scanning line on a surface of a scanning target. The fine adjustment unit includes a shifting unit that shifts a support position of a support unit that supports the mirror in a direction opposite to the direction of a second force exerted by a center-positioned adjustment unit depending on a strength of the second force.

### BRIEF DESCRIPTION OF THE DRAWINGS

A more complete appreciation of the invention and many of the advantages thereof may be obtained as the same becomes better understood by reference to the following detailed description when considered in connection with the accompanying drawings, wherein:

FIG. 1 is an oblique perspective view of a photoreceptor and a main scanning line;

FIG. 2 is a magnified view showing the reflecting mirror and associated configuration in an optical scanner;

FIG. 3 is a schematic diagram of the reflecting mirror that is forcibly curved by plate spring members;

FIGS. 4 and 5 are schematics showing curvature of the reflecting mirror;

FIG. 6 is a schematic diagram showing the main scanning lines on one of the plurality of photoreceptors correction;

FIG. 7 is a schematic diagram showing the main scanning lines on the other photoreceptor correction;

FIG. 8 is a schematic diagram of an illustrative embodiment of a printer according to a present disclosure;

FIG. 9 is a schematic diagram of the image forming station for yellow color;

FIG. 10 is a schematic diagram of an optical write unit of the printer according to the illustrative embodiment together with four photoreceptors;

FIG. 11 is a plan view showing the reflecting mirror and associated configuration viewed from a direction orthogonal to a light path;

FIG. 12 is a side view showing a curvature-adjustment pulse motor and a curvature adjuster of a forcible-curving unit;

FIG. 13 is a plan view showing a motor holder and the curvature adjuster of the forcible-curving unit;

FIG. 14 is an oblique perspective view showing the reflecting mirror and a holder;

FIG. 15 is a side view showing the holder and the reflecting mirror viewed from one end of thereof in a longitudinal direction;

FIG. 16 is a side view showing the holder and the reflecting mirror viewed from other end thereof in the longitudinal direction;

FIGS. 17A and 17B are schematic diagrams representing wave heights in different conditions;

FIGS. 18A and 18B are schematic diagrams illustrating curvature of the scanning lines;

FIG. 19 is a schematic diagram showing the main scanning line at an initial state and after adjustment;

FIG. 20 is a plan view showing the reflecting mirror and the associated configuration in a modified example;

FIG. 21 is a side view showing the holder and the reflecting mirror in the modified example viewed from a side of the reflecting mirror in a longitudinal direction; and

FIG. 22 is a schematic diagram showing a cam member used as a support means.

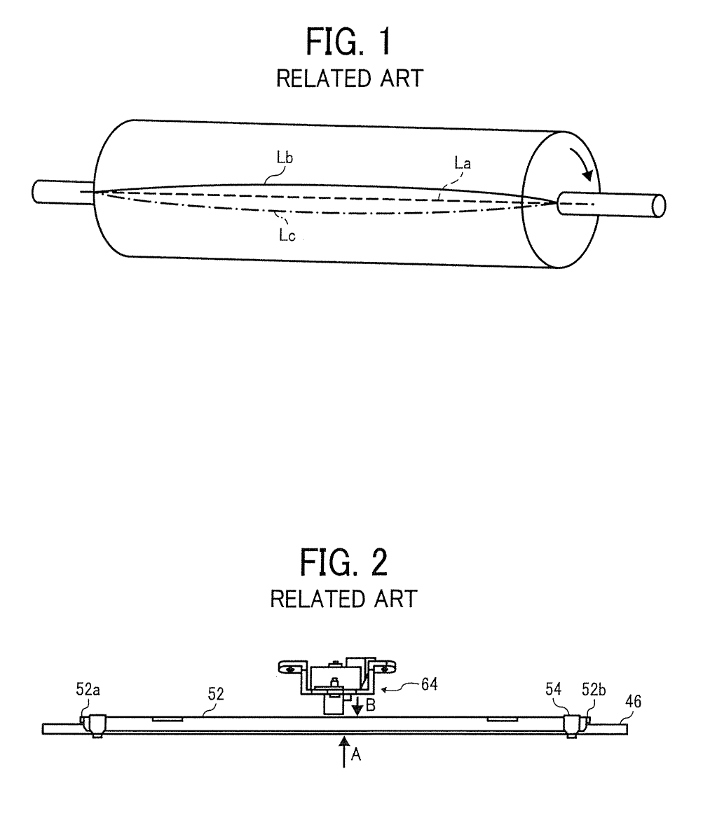

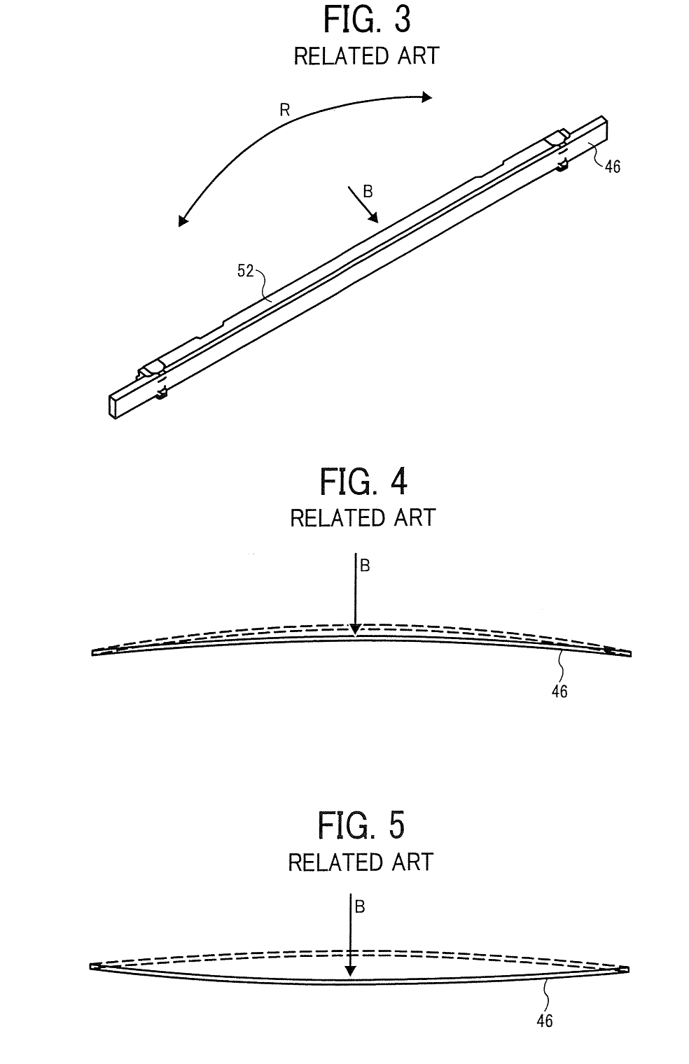

### DETAILED DESCRIPTION OF ILLUSTRATIVE EMBODIMENTS

In describing embodiments illustrated in the drawings, specific terminology is employed for the purpose of clarity. However, the disclosure of this patent specification is not intended to be limited to the specific terminology so used, and it is to be understood that substitutions for each specific element can include any technical equivalents that operate in a similar manner and achieve a similar result.

Referring now to the drawings, wherein like reference numerals designate identical or corresponding parts throughout the several views, a description is given of an illustrative embodiment.

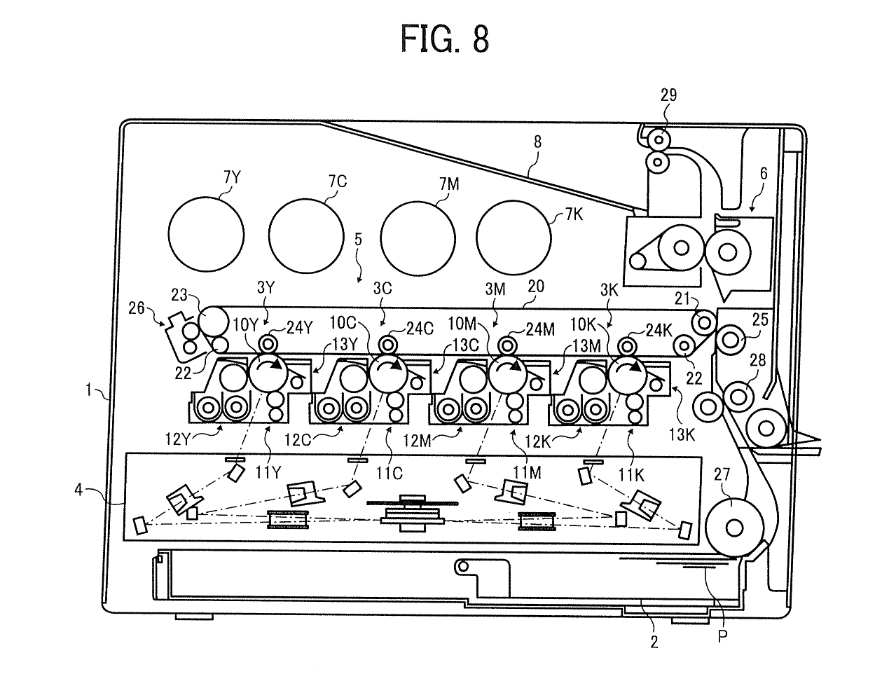

FIG. 8 is a schematic diagram of an illustrative embodiment of a color laser printer (hereinafter “printer”) that employs an electrophotographic method according to the present disclosure. The printer includes a main body 1 and a cassette 2 detachably provided to the main body 1. Further, the printer includes image forming stations 3Y, 3C, 3M, and 3K in a center of the portion of the main body 1. Each of the image forming stations 3Y, 3C, 3M, and 3K forms each color toner image (visible image) yellow (Y), magenta (M), cyan (C), and black (K) image respectively. Hereinafter, subscripts Y, C, M, and K of reference characters represent a member used for respective color.

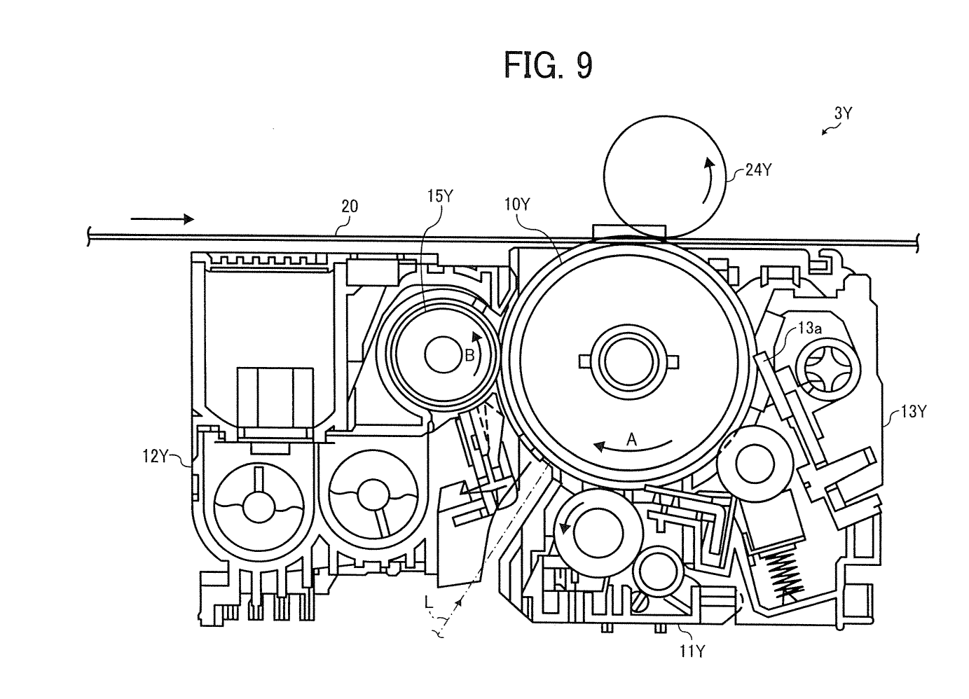

FIG. 9 is a schematic diagram of the image forming station for yellow color (Y). Other image forming stations for other colors have a configuration similar to that for the image forming stations for yellow color (Y), and therefor descriptions thereof are omitted.

As shown in FIGS. 8 and 9, each image forming station 3Y, 3C, 3M, and 3K includes a photoreceptor 10Y, 10C, 10M, and 10K having a drum shape, is an electrostatic latent image bearing member, and rotates in a direction indicated by an arrow. Each of the photoreceptors 10Y, 10C, 1CM, and 10K includes a cylindrical-aluminum-base tube having a diameter of 40 mm and a photosensitive layer formed of, for example, OPC (organic photo conductor) that covers the cylindrical-aluminum-base tube. Each image forming station 3Y, 3C, 3M, and 3K includes a charging device 11Y, 11C, 11M, or 11K, respectively, provided around the photoreceptor 10Y, 10C, 10M, and 10K to charge the photoreceptor 10Y, 10C, 10M, and 10K. Further, each of the image forming stations 3Y, 3C, 3M, and 3K includes a developing device 12Y, 12C, 12M, or 12K, respectively, that develops the electrostatic latent image formed on the photoreceptor 10Y, 10C, 10M, and 10K, and residual toner on the photoreceptor 10Y, 10C, 10M, and 10K is cleaned by cleaning devices 13Y, 13C, 13M and 13K.

An optical write unit 4 is provided beneath the image forming station 3Y, 3C, 3M, and 3K. The optical write unit 4 scans the photoreceptors 10Y, 10C, 10M, and 10K with an optical write beam L on. Further, an intermediate transfer unit 5 is provided above the image forming station 3Y, 3C, 3M, and 3K. The intermediate transfer unit 5 includes an intermediate transfer belt 20 on which toner image formed by the image forming station 3Y, 3C, 3M, and 3K is transferred. Further, a fixing unit 6 is also provided above the image forming station 3Y, 3C, 3M, and 3K. The fixing unit 6 fixes the toner image transferred from the intermediate transfer belt 20 onto a sheet of recording paper P.

Toner bottles 7Y, 7C, 7M, and 7K are provided at an upper part of the main body 1. Each of the toner bottles 7Y, 7C, 7M, and 7K stores one color toner, yellow (Y), magenta (M), cyan (C), and black (K), respectively. The toner bottles 7Y, 7C, 7M, and 7K can be detached from the main body 1 when the paper-outputting tray 8 is opened.

The optical write unit 4 that is an optical scanner includes a laser diode that is a light emitting device. The laser diode directs the optical write beam L that is an optical beam onto a polygon mirror. The polygon mirror is a regular polygon rotatably driven. The optical write beam L is reflected at a reflecting surface of the polygon mirror by deflecting the optical beams in a main scanning direction. After the optical write beam L is reflected at a plurality of mirrors, the reflected optical write beam L is scanned on a circumferential surface of each of the photoreceptors 10Y, 10C, 10M, and 10K charged uniformly by the charging device 11Y, 11C, 11M, and 11K. By this process, electrostatic latent images for each color Y, C, M, and K are formed on the circumferential surfaces of each of the photoreceptor 10Y, 10C, 10M, and 10K. The optical write unit 4 is described in detail later.

The intermediate transfer belt 20 is wound around a driving roller 21, a tension roller 22, and a dependent roller 23, and is rotatably driven in a counterclockwise direction with a predetermined timing. The intermediate transfer unit 5 includes primary transfer rollers 24Y, 24C, 24M, and 24K. The primary transfer roller 24Y, 24C, 24M, and 24K primarily transfers toner image formed on the photoreceptor 10Y, 10C, 10M, and 10K to the intermediate transfer belt 20. The intermediate transfer unit 5 further includes a secondary transfer roller 25 and a belt cleaning device 26. The secondary transfer roller 25 transfers secondarily toner image transferred on the intermediate transfer belt 20 to the recording paper P. The belt cleaning device 26 removes residual toner which is not transferred to the recording paper P from the intermediate transfer belt 20 during secondary transfer.

A description is now given of a color image forming process performed by the printer according to the present disclosure.

In each of the image forming stations 3Y, 3C, 3M, and 3K, the photoreceptors 10Y, 10C, 10M, and 10K are each charged uniformly by the charging device 11Y, 11C, 11M, and 11K, respectively. The optical write beam L is generated based on image information, and is scanned on the photoreceptors 10Y, 10C, 10M, and 10K to form electrostatic latent image on the surfaces of each of the photoreceptors 10Y, 10C, 10M and 10K. The electrostatic latent images are then developed on respective developing rollers 15Y, 15C, 15M, and 15K of the developing devices 12Y, 12C, 12M, and 12K to form color toner images Y, C, M, and K.

The color toner images Y, C, M, and K on the photoreceptor 10Y, 10C, 10M and 10K are primary-transferred by superimposing each color sequentially onto the intermediate transfer belt 20 that is rotatably driven in a counterclockwise direction by each of the primary transfer rollers 24Y, 24C, 24M, and 24K. Image-forming operations are performed sequentially with a predetermined timing delay to adjust the timing of the image-forming operation. Accordingly, each toner image is transferred by matching each position of the color images, and each color image-forming operation is performed with a timing delay from upstream to downstream in a moving direction of the intermediate transfer belt 20 so that the toner image is always transferred at the same position on the intermediate transfer belt 20.

After the above-described primary transfer operation, surfaces of the photoreceptors 10Y, 10C, 10M, and 10K are cleaned by a cleaning blade 13a of the cleaning devices 13Y, 13C, 13M, and 13K to prepare for a subsequent image forming operation.

The toner stored in the toner bottles 7Y, 7C, 7M, and 7K is supplied in predetermined amounts to the developing devices 12Y, 12C, 12M, and 12K in the image forming stations 3Y, 3C, 3M, and 3K through a conveyance path, not shown. The recording paper P stacked in a paper cassette 2 is conveyed into the main body 1 by a paper feed roller 27 provided near the paper cassette 2. Then, the recording paper P is conveyed to a secondary transfer unit with a predetermined timing by a resist roller pair 28.

At the secondary transfer unit, the toner image formed on the intermediate transfer belt 20 is transferred to the recording paper P. The toner image is fixed while the recording paper P passes through a fixing unit 6. Then, the recording paper P is output to a paper-output tray 8 by a paper output roller 29. As with the photoreceptors 10Y, 10C, 10M, and 10K, residual toner on the intermediate transfer belt 20 which is not transferred is removed by the belt cleaning device 26 configured to contact the intermediate transfer belt 20.

A description is now given of a configuration of the optical write unit 4.

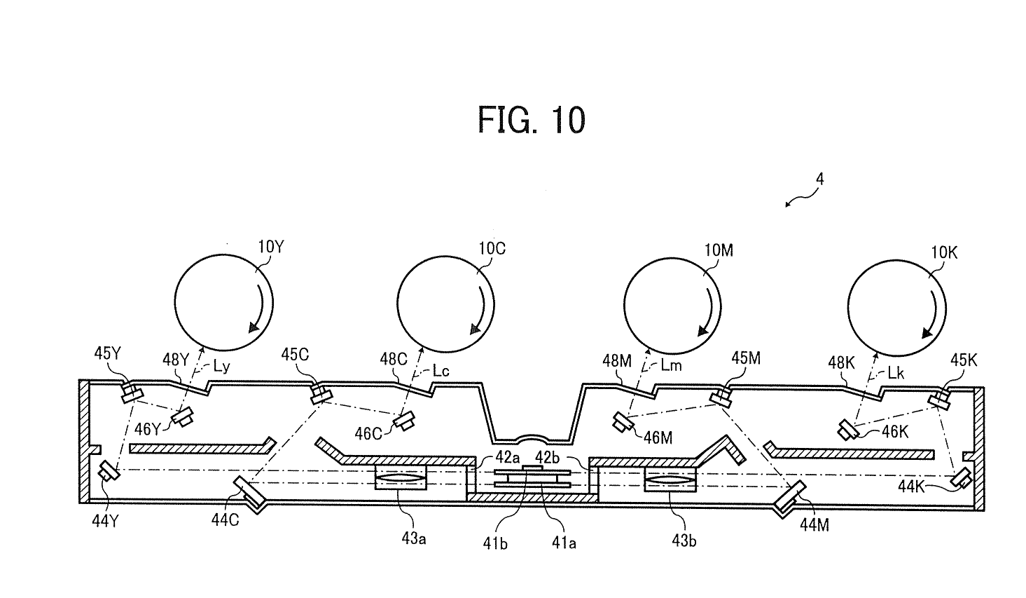

FIG. 10 is a schematic diagram of the optical write unit 4 of the printer according to the illustrative embodiment together with four photoreceptors. The optical write unit 4 includes two polygon mirrors 41a and 41b having a regular hexagonal shape, with reflecting mirrors at all six side surfaces. Further, the polygon mirrors 41a and 41b are positioned concentrically, and connected by a column or shaft of reduced diameter. The polygon mirrors 41a and 41b are driven by a polygon motor, not shown, to rotate with high speed about a single axis of rotation.

When the optical write beam (optical beam) emitted from the laser diode (optical beam emitting mechanism) irradiates the side surfaces of the polygon mirror, the optical write beam is deflected to scan. The optical write beams Lc and Lm for cyan (C) color and magenta (M) color, respectively, enter from a direction other than the main scanning direction. Accordingly, the polygon mirror 41a deflects the optical write beams Lc and Lm in the main scanning direction. Similarly, the polygon mirror 41a deflects the optical write beams Ly and Lk for yellow (Y) color and black (K) color, respectively, in the main scanning direction. In the optical write unit 4 as shown in FIG. 10, a deflection mechanism that deflects the optical write beams is formed of the polygon mirrors 41a and 41b and the polygon motor, not shown.

In addition to the deflection mechanism, the optical write unit 4 further includes four reflecting optical systems, soundproof glass panes 42a and 42b, scanning lenses 43a and 43b, and dust-proof glass panes 48a, 48b, 48c, and 48d. The polygon motor and the polygon mirrors 41a and 41b are covered by a polygon cover member for soundproofing. The polygon cover member includes the soundproof glass panes 42a and 42b to allow the optical write beam to travel inside and outside of the polygon cover member. Accordingly, the optical write beam can pass through the soundproof glass panes 42a and 42b so that the optical write beam goes into and out of the polygon cover member. The optical write beams Ly and Lc for yellow (Y) color and cyan (C) color pass through the soundproof glass pane 42a. The optical write beams Lm and Lk for magenta (M) color and black (K) color pass through the soundproof glass pane 42b.

The optical write beams Ly and Lc for yellow (Y) color and cyan (C) color are deflected in the main scanning direction by the polygon mirrors, pass through the soundproof glass pane 42a, and then pass through the scanning lenses 43a arranged one above the other. The scanning lenses 43a changes a motion of the optical write beams Ly and Lc output from the polygon mirror from an equiangular motion in the main scanning direction to a linear-constant-speed motion by focusing the optical write beams Ly and Lc in the main scanning direction and sub-scanning direction. Further, the scanning lenses 43a contribute to face-tangle-error-correction of the polygon mirror. The optical write beams Lm and Lk for magenta (M) color and black (K) color pass through the soundproof glass pane 42b, and then pass through the scanning lenses 43b provided at a side opposite the side on which the scanning lenses 43a are disposed.

The four optical systems in the optical write unit 4 include the laser diode as described above, reflecting mirrors, and so on. The optical system for Y color will be described more specifically as one example of the optical systems for each Y, C, M and K color.

The optical system for Y color includes a laser diode, not shown, a first reflecting mirror 44Y, a second reflecting mirror 45Y, and a third reflecting mirror 46Y. These reflecting mirrors have no lens function. Similarly to the optical system for Y color, the optical systems for C, M, and K color each respectively includes a laser diode, first reflecting mirrors 44C, 44M, and 44K, second reflecting mirrors 45C, 45M, and 45K, and third reflecting mirrors 46C, 46M, and 46K.

The optical write beams Ly, Lc, Lm, and Lk for Y, C, M, and K color that pass through the scanning lenses 43a and 43b travel to each reflecting mirror of the respective Y, C, M and K color optical systems. For example, the optical write beam Ly for Y color that passes through the scanning lenses 43a is directed onto a surface of the photoreceptor 10Y for Y color by being reflected three times sequentially, at the first reflecting mirror 44Y, the second reflecting mirror 45Y, and the third reflecting mirror 46Y.

Similarly to the optical write beam Ly for Y color, the optical write beams Lc, Lm, and Lk for C, M, and K color are directed onto surfaces of the photoreceptors 10C, 10M, and 10K, respectively, by being reflected at the three reflecting mirrors dedicated to each color. The optical write beams Ly, Lc, Lm, and Lk are reflected at the third reflecting mirror 46Y, 46C, 46M, and 46K, and arrive at the surfaces of the photoreceptors 10Y, 10C, 10M, and 10K after passing the dust-proof glass panes 48a, 48b, 48c, and 48d provided on an upper surface of the optical write unit 4.

A description is now given of a configuration of the printer according to the illustrative embodiment.

The optical write unit 4 of the printer includes the curvature-adjustment mechanism which is the curvature-adjustment means to correct the direction and amount of curvature of the main scanning line by adjusting the curvature of at least one reflecting mirror. The curvature-adjustment mechanism of the optical system for Y color will be described in detail as a representative example.

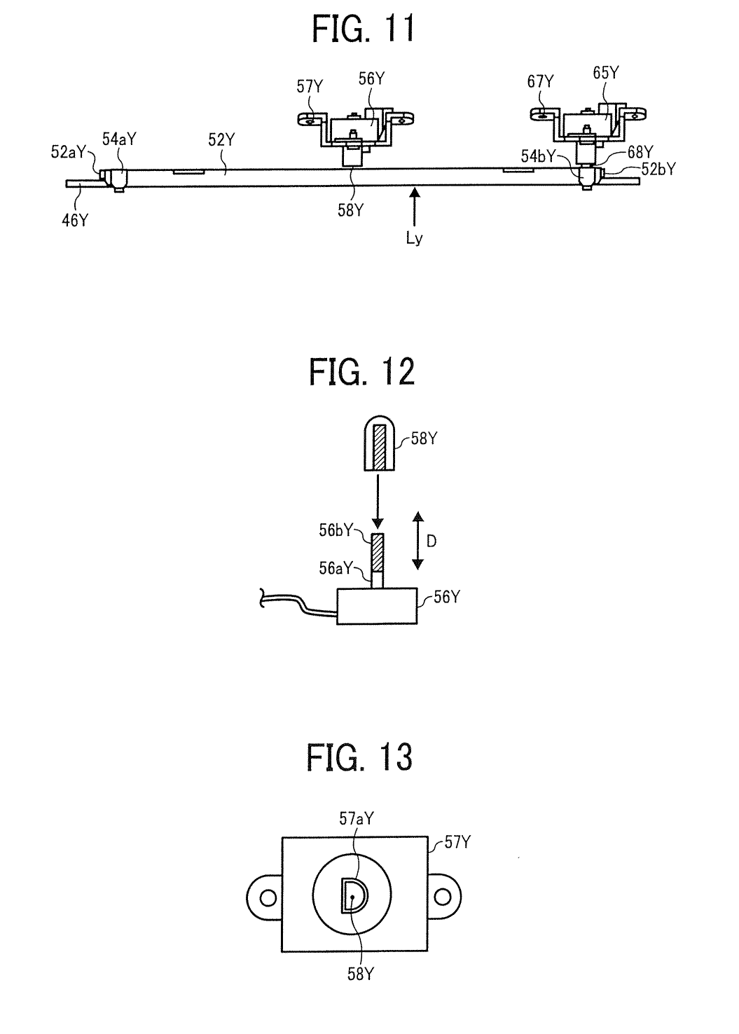

FIG. 11 is a plan view showing the third reflecting mirror 46Y and an associated configuration viewed from a direction orthogonal to a light path. In FIG. 11, the third reflecting mirror 46Y is held with a holder 52Y having a reversed-C-shape provided on a rear surface of the third reflecting mirror 46Y.

Both ends of the third reflecting mirror 46Y in a longitudinal direction thereof extend past both ends of the holder 52Y in the longitudinal direction. Further, a forcible-curving unit that includes the curvature-adjustment pulse motor 56Y, and a motor holder 57Y is fixed on a rear surface of the holder 52Y. The forcible-curving unit is a center-positioned forcible-curving means.

FIG. 12 is a side view showing the curvature-adjustment pulse motor 56Y and the curvature adjuster 5BY of the forcible-curving unit. Further, FIG. 13 is a plan view showing the motor holder 57Y and the curvature adjuster 58Y of the forcible-curving unit. As shown in FIG. 12, a male screw 56bY is formed on a rotating shaft 56aY of the curvature-adjustment pulse motor 56Y. The curvature adjuster 58Y includes a female screw, and is fixed to the rotating shaft 56aY by engaging the female screw with the male screw 56bY. The curvature adjuster 58Y has a D-shaped cross-section as shown in FIG. 13, and is inserted into the curvature-adjuster-insertion slot 57aY that also has a similar D-shaped cross-section and is provided on the motor holder 57Y. Accordingly, the curvature adjuster 58Y does not rotate even when the rotating shaft 56aY rotates because the curvature adjuster 58Y is locked in place by the curvature adjuster insertion slot 57aY. Further, the curvature adjuster 58Y moves up and down in a direction represented by arrow D in FIG. 12 because the screw is fed by rotation of the rotating shaft 56aY.

A top portion of the curvature adjuster 58Y that is engaged with the screw of the rotating shaft of the curvature-adjustment pulse motor 56Y contacts a center portion of a rear surface of the third reflecting mirror 46Y in the longitudinal direction. When the curving adjuster (58Y in FIG. 12) that is engaged with the rotating shaft of the curvature-adjustment pulse motor 56Y moves up and down according to a rotation of the rotating shaft 56aY, a curving amount to the center portion of the rear surface of the third reflecting mirror 46Y in the longitudinal direction changes.

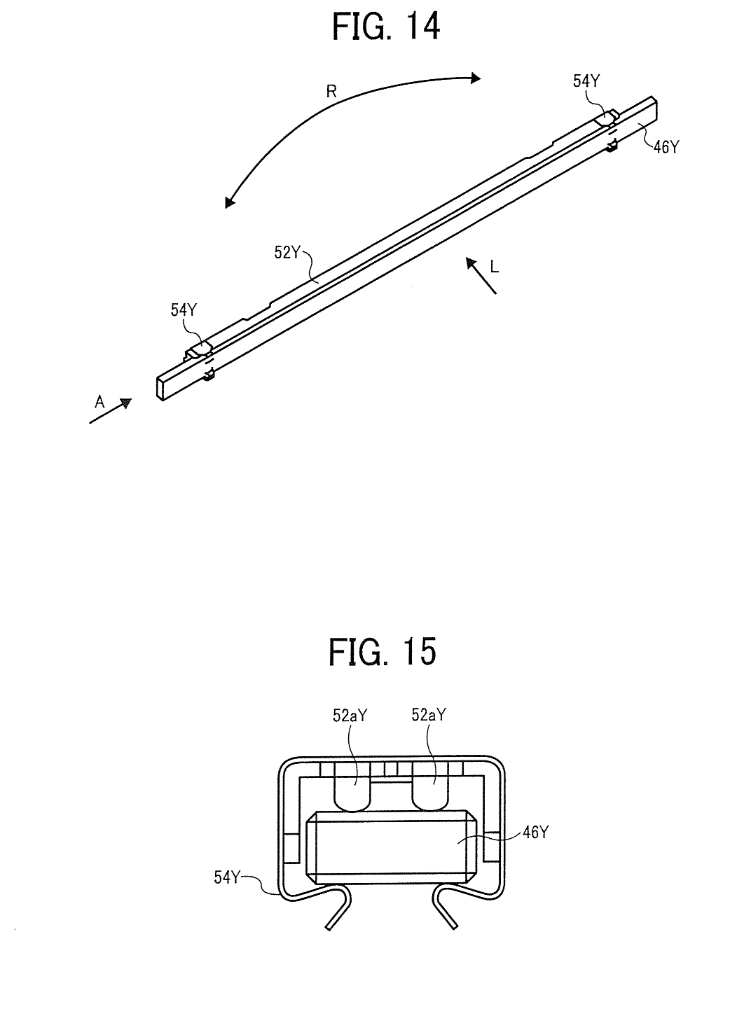

FIG. 14 is an oblique perspective view viewed from a mirror side of the third reflecting mirror 46Y, showing the third reflecting mirror 46Y and the holder 52Y that holds the third reflecting mirror 46Y. In FIG. 14, the third reflecting mirror 46Y is held by plate spring members 54Y together with the holder 52Y. Each plate spring member 54Y has C-shaped end portions at both ends, is formed of steel, and is an edge-positioned forcible-curving means.

As shown in FIG. 11, support projections 52aY and 52bY are provided at both ends of the holder 52Y in the longitudinal direction thereof and extends to the third reflecting mirror 46Y. The support projection 52aY is a support means. Each one of the two plate spring members 54aY and 54bY that bind the holder 52Y and the third reflecting mirror 46Y together at both ends of the holder 52Y is provided at a position inboard of the support projection 52aY and 52bY of the holder 52Y.

The first plate spring member 54aY placed at one end (left end in FIG. 11) is locked to the holder 52Y. The second plate spring member 54bY placed at other end (right end in FIG. 11) is fixed to a bias-force-fine adjustment means that changes a pressure force (bias force). The third reflecting mirror 46Y of the second plate spring member 54bY is forcibly curved by the pressure force. The bias-force-fine adjustment means includes a bias-force-adjusting pulse motor 65Y, a motor holder 67Y and a bias-force adjuster 68Y that is engaged with a rotating shaft of the bias-force adjusting pulse motor 65Y.

FIG. 15 is a side view showing the holder 52Y and the third reflecting mirror 46Y viewed from one end of thereof in a longitudinal direction. As shown in FIG. 15, the support projection 52aY of the holder 52Y contacts the rear surface of the third reflecting mirror 46Y. Meanwhile, the first plate spring member 54aY that binds the holder 52Y and the third reflecting mirror 46Y together includes two plate spring portions formed at both leading edges in opening side of the first plate spring member 54aY. The plate spring portion hooks the third reflecting mirror 46Y at the both leading edges thereof in a height direction. Accordingly, each plate spring portion provides a pressure force to the third reflecting mirror 46Y from the mirror side to the rear side thereof.

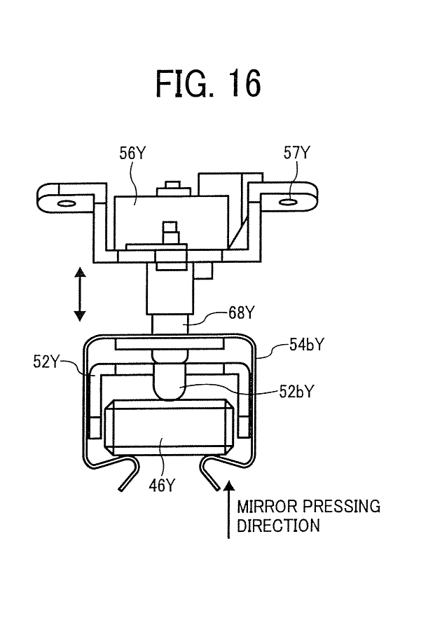

FIG. 16 is a side view showing the holder 52Y and the third reflecting mirror 46Y viewed from another end thereof in the longitudinal direction. As shown in FIG. 16, the support projection 52bY of the holder 52Y also contacts the rear surface of the third reflecting mirror 46Y at the other side thereof. Similarly to the first plate spring member 54aY, the second plate spring member 54bY includes two plate spring portions formed at leading edges in opening side of the second plate spring member 54bY. The plate spring portion hooks the third reflecting mirror 46Y at both edges thereof in a height direction. Accordingly, each plate spring portion provides a pressure force to the third reflecting mirror 46Y from the mirror side to the rear side thereof.

Further, at the other side, the second plate spring member 54bY that binds the holder 52Y and the third reflecting mirror 46Y together is fixed to the bias-force adjuster 68Y of the bias-force-fine adjustment means. When the bias-force-fine adjustment means moves up and down as shown in FIG. 12 using the same similar principal as that for the curvature adjuster 58Y of the forcible-curving unit, the pressure force (bias force) exerted on the reflecting mirror at the plate spring portions of the second plate spring member 54bY is changed by sliding the second plate spring member 54bY in a direction orthogonal to the reflecting surface of the third reflecting mirror 46Y.

The first and second plate spring members 54aY and 54bY push against the third reflecting mirror 46Y at positions closer to the center of the third reflecting mirror 46Y in the longitudinal direction than the support projections 52aY and 52bY of the holder 52Y as shown previously in FIG. 11. The third reflecting mirror 46Y receives the pressure force at these positions, and curves in a form represented by arrow R in FIG. 14. Accordingly, a center portion of the third reflecting mirror 46Y is curved in a direction extending from a front surface to the rear surface of the third reflecting mirror 46Y. Further, the third reflecting mirror 46Y is held in place by the holder 52Y in a state of curvature in which the third reflecting mirror 46Y is forcibly curved by the first and second plate spring members 54aY and 54bY.

In FIG. 11, it is hard to see with the naked eye whether the third reflecting mirror 46Y is curved or not. However, the center portion of the third reflecting mirror 46Y in the longitudinal direction is actually curved by the first and second plate spring members 54aY and 54bY towards the forcible-curving means. The curvature adjuster 58Y of the forcible-curving means pushes the center portion of the third reflecting mirror 46Y in a direction opposite to the direction of a forcible curve to the third reflecting mirror 46Y caused by the holder 52Y and the first and second plate spring members 54aY and 54bY. With this configuration in the reflecting optical system, the curvature of the third reflecting mirror 46Y can be 20 corrected.

As described previously, it is possible to curve the third reflecting mirror 46Y in any direction (to the rear surface side or to the reflecting surface side) in this reflecting optical system. Accordingly, with respect to a main scanning line on the surface of the photoreceptor, any curvature to upstream or downstream sides of the sub-scanning direction can be corrected.

In an initial state, the forcible-curving means does not push the third reflecting mirror 46Y. Accordingly, the bias-force adjuster 68Y of the bias-force-fine adjustment means shifts the second plate spring member 54bY to a position near the bias-force-line adjustment means so as to increase the pressure force (bias force) of the second plate spring member 54bY exerted on the third reflecting mirror 46Y. In this condition, a curving force to forcibly curve the third reflecting mirror 46Y increases so that the third reflecting mirror 46Y curves desirably in the initial state.

When the curvature adjuster 58Y of the forcible-curving unit pushes the center portion of the third reflecting mirror 46Y in a direction opposite to the direction of the pressure force to the third reflecting mirror 46Y caused by the holder 52Y and the first and second plate spring members 54aY and 54bY, the bias-force adjuster 68Y of the bias-force-fine adjustment means shifts the second plate spring member 54bY by sliding in the same direction as the direction of a pushing force exerted by the forcible-curving unit. Accordingly, the pressure force of the second plate spring member 54bY on the third reflecting mirror 46Y is reduced. Thus, the curving force with which the forcible-curving unit forcibly curves the third reflecting mirror 46Y is reduced.

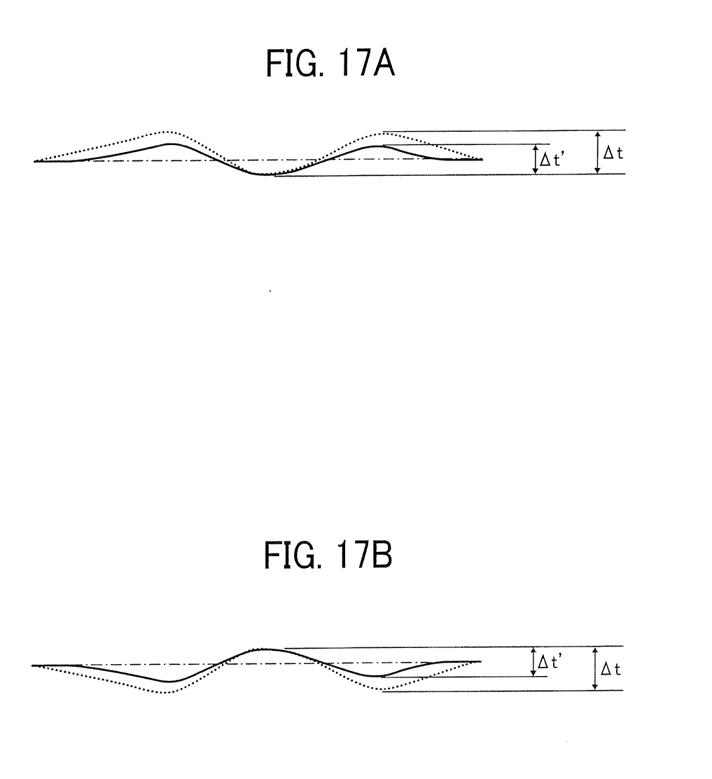

FIGS. 17A and 17B are schematic diagrams representing wave heights Δt and Δt′ in different conditions of curvature of the mirror. The wave height Δt is an initial value before the pressure force of the second plate spring member 54bY on the third reflecting mirror 46Y is changed, whereas the wave height Δt′ is obtained when the pressure force of the second plate spring member 54bY on the third reflecting mirror 46Y is changed depending on a pressing amount by the forcible-curving unit. As shown in FIGS. 17A and 17B, the wave height can be reduced by reducing the pressure force of the second plate spring member 54bY on the third reflecting mirror 46Y.

The curvature-adjustment means of the reflecting optical system for Y color that includes the holder, the plate spring member, the forcible-curving means, and bias-force-fine adjustment means have been described in the preceding section. Each curvature-adjustment means of the reflecting optical system for C, M and K color has a configuration similar to that for Y color.

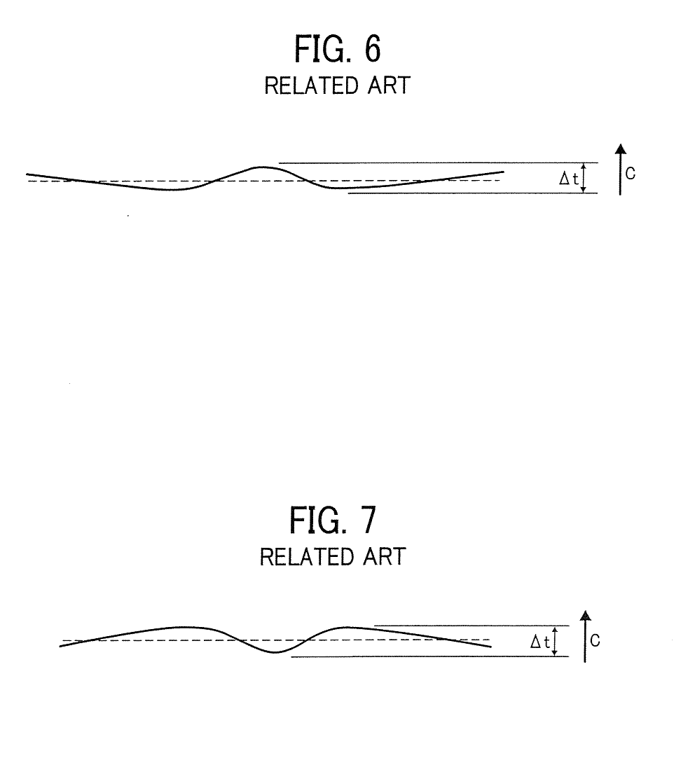

In the reflecting optical systems for Y and C colors, each main scanning line on the photoreceptor 10Y and 10C has the shape of the letter “W” as shown in FIG. 6. By contrast, in the reflecting optical systems for M and K color, each main scanning line on the photoreceptor 10M and 10K has the shape of the letter “M” as shown in FIG. 7.

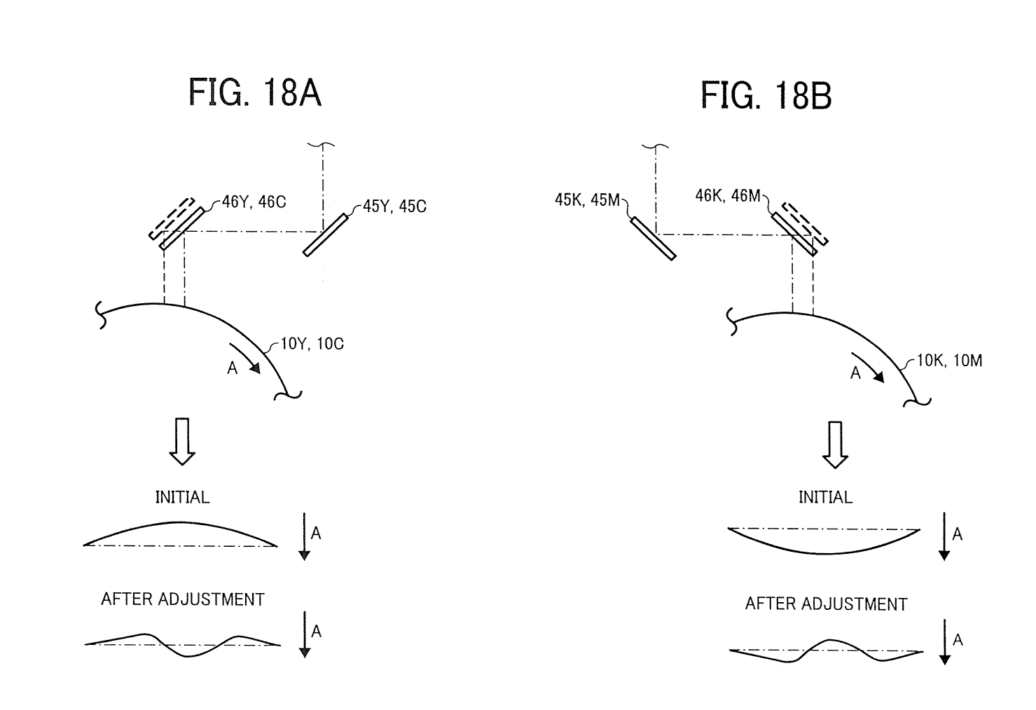

FIG. 18A is a schematic diagram illustrating curvature of the scanning lines for Y and C color. FIG. 18B is a schematic to explain curvature of the scanning lines for M and K color.

In the reflecting optical systems for Y and C color, each reflecting surface of the third reflecting mirrors 46Y and 46C faces to the right as shown in FIG. 18A. By contrast, in the reflecting optical systems for M and K color, each reflecting surface of the third reflecting mirror 46M and 46K faces to the left as shown in FIG. 18B.

In the reflecting optical systems for Y and C color, the center of each of the third reflecting mirrors 46Y and 46C is a position shown by a dotted line in FIG. 18A in the initial state in which the third reflecting mirror 46Y and 46C is curved. Accordingly, in the initial state, the optical write beam reflected at the center of the third reflecting mirror 46Y and 46C is exposed on an upstream position in a moving direction of the photoreceptor 10Y and 10C in comparison with an exposure position of the optical write beam after adjustment. Thus, the scanning line at the initial state is curved, and the center of the scanning line curves to the upstream side in the moving direction of the photoreceptor 10Y and 10C in comparison to a desired scanning line. The scanning line has the shape of the letter “M” after adjustment.

By contrast, in the reflecting optical systems for M and K color, the scanning line at the initial state is curved so that the center of the scanning line curves to the downstream side in the moving direction of the photoreceptor 10M and 10K in comparison with a desired scanning line. The scanning line has the shape of the letter “W” after adjustment.

In the reflecting optical systems, the third reflecting mirror is positioned at the extreme downstream side with respect to a light path among the plurality of the reflecting mirrors. The third reflecting mirrors for Y and C color face in the opposite direction from that of the third reflecting mirrors for M and K color because the relative positions of the third reflecting mirrors and the optical systems are different. More specifically, in the reflecting optical system for Y color, the sub-scanning line is a tangent to the photoreceptor 10Y and the optical write beam Ly, and moves from right to left in FIG. 10.

Referring to FIG. 10, the reflecting optical system for Y color is located downstream from the polygon mirror 41b in the sub-scanning direction as described previously. Similarly, the reflecting optical system for C color is also located downstream from the polygon mirror 41a in the sub-scanning direction.

By contrast, the reflecting optical systems for M and K color are located upstream side from the polygon mirrors 41a and 41b in the sub-scanning direction. The reflecting mirrors arranged in the same order face in different directions because of the different relative positions of the reflecting mirror and the optical systems.

The relative positions of the reflecting optical systems for M and K color and the polygon mirrors 41a and 41b in the sub-scanning direction are opposite the relative positions of the reflecting optical systems for M and K color and the polygon mirrors 41a and 41b in the sub-scanning direction. This is because the polygon mirrors 41a and 41b are provided between the reflecting optical systems for M and K color on the one hand and the reflecting optical systems for M and K color on the other. This layout is employed to obtain a compact apparatus and achieve a high accuracy of the scanning position.

More specifically, referring to all the reflecting-optical systems, if positions of the polygon mirrors 41a and 41b at upstream or downstream in the sub-scanning direction are placed further to the left than the reflecting optical system for Y color, which is already located at the extreme left side, or are placed further to the right than the reflecting optical system for K color that is already located at the extreme right side, horizontal layout broadens. Such a configuration prevents downsizing the apparatus.

Further, if the polygon mirrors 41a and 41b are placed further to the left than the reflecting optical system for Y color, scanning accuracy decreases because a light path between the polygon mirrors and the reflecting optical system for K color located at the extreme right side becomes relatively long. Similarly, if the polygon mirrors 41a and 41b are placed further to the right than the reflecting optical system for K color, scanning accuracy also decreases. For this reason, the polygon mirrors 41a and 41b are placed between the reflecting optical systems for Y and C color and the reflecting optical systems for M and K color.

In this illustrative embodiment, the bias-force-fine adjustment means is employed. The second plate spring member is moved by sliding by the forcible-curving unit of the bias-force-fine adjustment means depending on the pushing amount so that the pressure force exerted on the reflecting mirror by the second plate spring members is weakened. Accordingly, the curving force that forcibly curves the reflecting mirror is weakened and the wave height Δt is reduced as shown in FIGS. 17A and 17B. A misalignment in sub-scanning direction between a dot formed at a bottom position in the W-shaped scanning line and a dot formed at a peak position in the M-shaped scanning line is reduced. As a result, it is possible to reduce color misalignment.

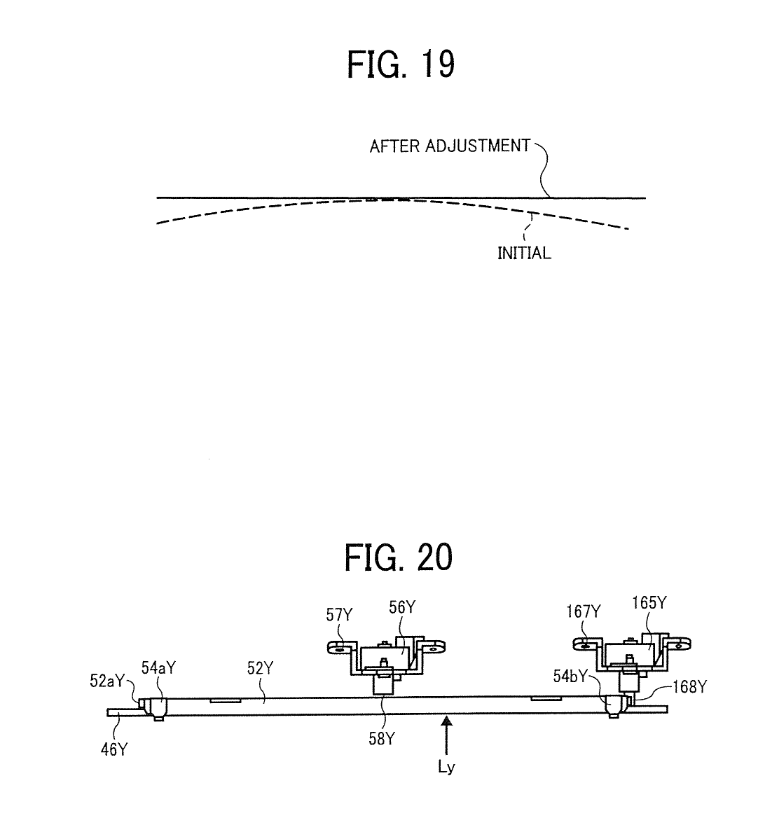

Curvature adjustment to adjust a main scanning line on the photoreceptor is performed when the printer is shipped. The curvature adjustment is also performed at certain predetermined times, for example, when a printing number reaches a predetermined number, or when an instruction by a user is received. In an initial state just after the printer is assembled, the reflecting mirror is curved as shown by arrow R in FIG. 14. In this initial state, the main scanning line is curved as shown by dotted line in FIG. 19.

When the curvature-adjustment pulse motor (for example, 56Y) of the curvature-adjustment means is rotated, the curving adjuster (for example, 58Y) is contacted against a center portion of the rear surface of the reflecting mirror (for example, 46Y) in a longitudinal direction. Then, as shown in FIG. 19, the curvature of the main scanning line in the initial state is adjusted by controlling a moving amount of the curving adjuster.

Further, the bias-force adjusting pulse motor (for example, 65Y) is rotated depending on rotational angle of the curvature-adjustment pulse motor (for example, 56Y). Accordingly, the bias-force adjuster (for example, 68Y) is elevated so as to change the pressure force exerted on the reflecting mirror (for example, 46Y) by the second plate spring member (for example, 54bY). As a result, the wave height Δt is reduced so that the misalignment in sub-scanning direction between the dot formed at the bottom position in the W-shaped scanning line and the dot formed at the peak position in the M-shaped scanning line is reduced.

When a printing number reaches a predetermined number or when an instruction by a user is received, the curvature adjustment is performed as follows: First, a predetermined electrostatic latent image for detecting positional misalignment is formed on the photoreceptor 10Y, 10C, 10M and 10K for each color shown in FIG. 10 by the same operation as a normal image forming operation. The electrostatic latent image for detecting positional misalignment is developed using the same operation as the normal image forming operation so as to form toner image for detecting positional misalignment for each color. Each toner image is primary-transferred to an intermediate transfer belt at separate positions to form a positional-misalignment-detection pattern for all colors. The positional-misalignment-detection pattern includes patterns arranged regularly.

While the intermediate transfer belt moves endlessly, each toner image for detecting positional misalignment that is formed on the intermediate transfer belt is detected by an optical sensor, not shown. A controller, not shown, recognizes an amount of the curvature of the main scanning line for each color Y, C, M and K based on the timing of detection of the toner images detected by the optical sensor. Then, the controller calculates a necessary curvature amount to minimize the recognized curvature of the main scanning line for each color Y, C, M, and K. Based on calculated curvature amount, the curvature-adjustment pulse motor (for example, 56Y) is rotated by a predetermined rotation angle in a clockwise direction or a counterclockwise direction. By this operation, direction of the curvature and the curvature amount of the reflecting mirror are adjusted. Thus, the curvature of the main scanning line in the initial state is corrected as shown by the dotted line in FIG. 19.

The bias-force adjusting pulse motor (for example, 65Y) is rotated in a clockwise direction or a counterclockwise direction depending on a rotational angle of the curvature-adjustment pulse motor (for example, 56Y) so that the bias-force exerted on the reflecting mirror (for example, 46Y) by the second plate spring member (for example, 54bY) is changed properly. More specifically, when the reflecting mirror is curved in a direction opposite the direction of the forcible curving force exerted by the plate spring members by rotating the curvature-adjustment pulse motor (for example, C6Y) in the clockwise direction, the second plate spring member is moved by sliding to weaken the pressure force exerted on the reflecting mirror by the second plate spring member. Accordingly, the curving force by the plate spring member to forcibly curve the reflecting mirror is weakened, and the wave height Δt is reduced.

By contrast, when the reflecting mirror is to be curved in a direction of the pressure force exerted by the plate spring member by rotating the curvature-adjustment pulse motor reversely in the counterclockwise direction, the second plate spring member is moved by sliding in a direction to strengthen the pressure force to the reflecting mirror by the second plate spring member. Accordingly, the curving-force by the plate spring member to forcibly curve the reflecting mirror is strengthened, and it is possible to forcibly curve the reflecting mirror desirably. Thus, it is possible to correct any curvature upstream or downstream in a sub-scanning direction at a main scanning line on a surface of the photoreceptor.

### MODIFIED EXAMPLE

A modified example of the curvature-adjustment means will be described.

FIG. 20 is a plan view showing the third reflecting mirror 46Y and the associated configuration in the modified example viewed from a direction orthogonal to a light path.

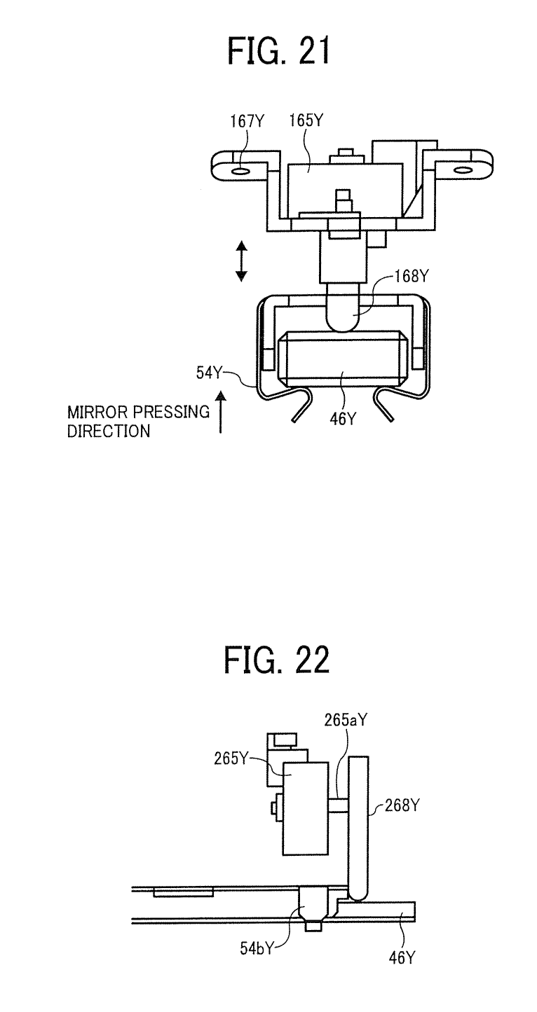

FIG. 21 is a side view showing the holder 52Y and the third reflecting mirror 46Y in the modified example viewed from a side of the third reflecting mirror 46Y in a longitudinal direction. As shown in FIGS. 20 and 21, in the modified example, one (right side in FIG. 20) of the support projections that are provided at both ends of the third reflecting mirror 46Y in the longitudinal direction thereof and support the third reflecting mirror 46Y is shifted in a direction perpendicular to the reflecting surface. As a result, the bias force (pressure force) of the second plate spring member 54bY to the third reflecting mirror 46Y is changed.

At one end of the third reflecting mirror 46Y (left side in FIG. 20), a configuration is similar to that shown in FIG. 15. By contrast, the support means that supports the third reflecting mirror 46Y is an adjuster 168Y at another end of the third reflecting mirror 46Y as shown in FIG. 21. The adjuster 168Y has a D-shaped cross-section similar to that in FIG. 13, is inserted to an adjuster-insertion slot having a D-shaped formed on the motor holder 167Y, and is engaged with a rotating shaft of a shift-adjusting pulse motor 165Y.

Accordingly, even when the rotating shaft of a shift-adjusting pulse motor 165Y rotates, the adjuster 168Y that is a support means does not rotate because the adjuster 168Y is fixed to an adjuster insertion of the motor holder 167Y. Then, the adjuster 168Y moves up and down because of a screw fed by a rotation of the rotating shaft.

Meanwhile, the second plate spring member 54bY that binds the holder 52Y and the third reflecting mirror 46Y includes two plate spring portions formed at leading edges in opening side of the second plate spring member 54bY. The plate spring portion hooks the third reflecting mirror 46Y at the both leading edges thereof in a height direction. Accordingly, each plate spring portion provides a pressure force to the third reflecting mirror 46Y from the mirror side to the rear side thereof.

At an initial state, the forcible-curving means does not push the third reflecting mirror 46Y.

The adjuster 168Y that is a support means is shifted to the same direction as a direction that the forcible-curving means pushes by rotating the shift-adjusting pulse motor 165Y with a positive rotation. In this condition, the pressure force that forcibly curve the third reflecting mirror 46Y increases so that the third reflecting mirror 46Y curves desirably at the initial state.

When the curvature adjuster 58Y of the forcible-curving unit pushes the center portion of the third reflecting mirror 46Y in a direction opposite the direction of the forcible curving force to the third reflecting mirror 46Y caused by the holder 52Y and the first and second plate spring members 54aY and 54bY, the adjuster 168Y is shifted in a direction opposite the direction to which the forcible-curving means pushes by rotating the shift-adjusting pulse motor 165Y with a reverse rotation. Accordingly, the pressure force of the second plate spring member 54bY to the third reflecting mirror 46Y is reduced. As a result, the curving force that forcibly curve the third reflecting mirror 46Y is reduced. Consequently, the wave height Δt is reduced.

In the modified example described above, the support means is the adjustor. However, the support means can be a cam member 268 as shown in FIG. 22. As shown in FIG. 22, the cam member 268 is attached to an output shaft 265aY of a rotation-adjusting pulse motor 265Y. The rotation-adjusting pulse motor 265Y is a shifting means. A part of the cam member 268 contacts an end portion of the third reflecting mirror 46Y in the longitudinal direction. It is possible to change a support position at which the cam member 268 supports the third reflecting mirror 46Y in a direction perpendicular to the reflecting surface of the third reflecting mirror 46Y by controlling rotational angle of the rotation-adjusting pulse motor 265Y.

At an initial state, the forcible-curving means does not push the third reflecting mirror 46Y. The cam member 268Y is shifted to the same direction as a direction that the forcible-curving means pushes by rotating rotation-adjusting pulse motor 265Y. In this condition, the pressure force that forcibly curve the third reflecting mirror 46Y increases so that the third reflecting mirror 46Y curves desirably at the initial state.

When the curvature adjuster 58Y of the forcible-curving unit pushes the center portion of the third reflecting mirror 46Y in a direction opposite the direction of the forcible curving force to the third reflecting mirror 46Y caused by the holder 52Y and the first and second plate spring members 54aY and 54bY, a support position of the cam member 268 on the third reflecting mirror 46Y is shifted in a direction opposite the direction that the forcible-curving means pushes by rotating the rotation-adjusting pulse motor 265Y. Accordingly, the pressure force of the second plate spring member 54bY to the third reflecting mirror 46Y is reduced. As a result, the curving force that forcibly curve the third reflecting mirror 46Y is reduced. Consequently, the wave height Δt is reduced.

The curvature-adjustment mechanism is used for the optical write unit 4. As described, the optical write unit 4 scans an optical write beam on the photoreceptor and includes a laser diode that is an optical beam emission means, a deflection unit and mirrors that reflect the optical beam. The deflection unit includes the polygon motor and the polygon mirrors 41a and 41b which deflect the optical beam to a main scanning direction.

The curvature-adjustment mechanism includes support projections and a first and second plate spring members 54a and 54b. The support projections are provided at both ends of the reflecting mirror in a longitudinal direction thereof and support the reflecting mirror. The first and second plate spring members 54a and 54b are edge-positioned forcible-curving means to curve the reflecting mirror by providing a force to a reflecting surface perpendicular to the reflecting surface at different positions than support positions of the support projections. Further, the curvature-adjustment mechanism includes a forcible-curving means that is a center-positioned forcible-curving means and pushes a center portion of the reflecting mirror in a direction opposite the direction of forcible curving force to the reflecting mirror caused by the plate spring members.

Furthermore, the curvature-adjustment mechanism includes a bias-force-fine adjustment means that adjusts the curving force depending on the strength of the pushing amount by the forcible-curving means, for example by weakening the pressure force exerted on the reflecting mirror by the plate spring members. With this configuration, the curvature of the reflecting mirror by the plate spring members becomes small in a region between a pushing position of the forcible-curving means 64 and the support position of the support projection. As a result, it is possible to make the wave height Δt small as shown in FIGS. 6 and 7. Consequently, a misalignment in sub-scanning direction between a dot formed at a bottom position in the W-shaped scanning line and a dot formed at a peak position in the M-shaped scanning line is reduced.

As shown in the modified example, the curvature-adjustment means includes a shifting unit that shifts the support position of the support unit in a direction opposite the direction to which the center-positioned adjustment unit pushes the mirror depending on the strength of the pushing force provided by the center-positioned adjustment unit.

Further, the shifting unit includes a rotating shaft, a shift-adjusting pulse motor 165Y and a motor holder 167Y. The rotating shaft is engaged with the adjuster 168Y that is a support means. The shift-adjusting pulse motor 165Y controls a rotational angle of the rotation-adjusting pulse motor 165Y that drive to rotate the rotating shaft. The motor holder 167Y is a regulation means that regulates a movement in the rotational direction of the adjuster 168Y. Since the movement in the rotational direction of the adjuster 168Y is restricted by the motor holder 167Y, the adjuster 168Y does not rotate even when the shaft is rotated by the shift-adjusting pulse motor 165Y. Accordingly, the support position of the adjuster 168Y to the reflecting mirror is changed because the adjuster 168Y is fed. Further, using a pulse motor that can controls the rotational angle, it is possible to control the support position of the adjuster 168Y to the reflecting mirror accurately.

A cam member 268Y may be used as the support means, and the shifting means may include a rotational adjustment pulse motor 265 that can controls the rotational angle of the cam member 268. Controlling the rotational angle of the rotational adjustment pulse motor 265, it is possible to control the support position on the reflecting mirror by the cam member 268. Accordingly, the curving-force exerted on the reflecting mirror by the plate spring member that forcibly curves the reflecting mirror is weakened depending on a pressure amount to the reflecting mirror by the plate spring member.

Using the curvature-adjustment mechanism as an optical write unit that is a light scanning device, it is possible to correct the curvature of the main scanning line with respect to sub-scanning line desirably.

Further, the optical scanning device employs a single scanning lens 43 to focus the optical beam in this illustrative embodiment. Accordingly, it is possible to form an optical system with less number of parts in comparison to an optical system that includes an f-theta-lens that focuses the optical beam in a main scanning direction and a lengthy lens that focuses the optical beam in a sub-scanning direction. Consequently, it is possible to obtain a compact light scanning device and increase freedom in layout design.

Further, if the optical write unit is used in an image forming apparatus, it is possible to form a fine color image without color misalignment.

The above-described embodiments are illustrative and do not limit the present invention. Thus, numerous additional modifications and variations are possible in light of the above teachings. For example, elements at least one of features of different illustrative and exemplary embodiments herein may be combined with each other at least one of substituted for each other within the scope of this disclosure and appended claims. Further, features of components of the embodiments, such as their number, position, and shape, are not limited the embodiments and thus may be set as preferred. It is therefore to be understood that, within the scope of the appended claims, the disclosure of this patent specification may be practiced otherwise than as specifically described herein.

What is claimed is:

1. A curvature-adjustment device for an optical scanner, comprising:
an optical beam emission unit configured to emit an optical beam;
a deflection unit configured to deflect the optical beam in a main scanning direction; and
a mirror configured to reflect the optical beam,
the curvature-adjustment device configured to correct a curvature of a main scanning line on a surface of a scanning target and comprising:
a support unit configured to support the mirror at an end thereof in a longitudinal direction of the mirror by contacting a rear surface of the mirror;
an edge-positioned adjustment unit configured to curve the mirror by exerting a first force on the mirror perpendicular to a reflecting surface at a position different from a support position of the support unit with respect to the longitudinal direction of the mirror;
a center-positioned adjustment unit configured to curve the mirror by exerting a second force on the mirror perpendicular to the reflecting surface in a direction opposite the direction of the first force provided by the edge-positioned adjustment unit at substantially a center of the mirror in the longitudinal direction of the mirror; and
a fine adjustment unit configured to adjust a strength of the first force provided by the edge-positioned adjustment unit depending on a strength of the second force provided by the center-positioned adjustment unit.

2. The curvature-adjustment device of claim 1, wherein the fine adjustment unit includes a shifting unit that shifts the support position of the support unit in a direction opposite to the direction of the second force exerted by the center-positioned adjustment unit depending on the strength of the second force.

3. The curvature-adjustment device of claim 2, wherein the shifting unit further comprises:
a rotating shaft configured to screwably engage the support unit;
a motor configured to drive the rotating shaft and control a rotational angle of the rotating shaft; and
a regulation member configured to regulate movement of the support unit in a rotational direction.

4. The curvature-adjustment device of claim 2, wherein the support unit comprises a cam member, and the shifting unit includes a motor to control a rotational angle to rotate the cam member.

5. An optical scanner used in an image forming apparatus comprising the curvature-adjustment device of claim 1,
wherein the surface of the scanning target is scanned by the optical beam.

6. The optical scanner of claim 5, further comprising:
a scanning lens configured to focus the optical beam that is scanned in a main scanning direction and a sub-scanning direction.

7. An image forming apparatus comprising:
an image carrier configured to hold an electrostatic latent image;
a developing unit configured to develop the electrostatic latent image formed on the image carrier; and
the optical scanner of claim 5.
